(19) United States
(12) Patent Application Publication
(10) Pub. No.: US 2013/0173472 A1
(43) Pub. Date: Jul. 4, 2013

(54) Transaction Management System

(71) Applicant: Giampietro Trolio, West Perth WA (AU)

(72) Inventor: Giampietro Trolio, West Perth WA (AU)

(73) Assignee: Axieos Technologies Pty Ltd, Perth WA (AU)

(21) Appl. No.: 13/808,551

(22) PCT Filed: Jul. 6, 2011
(86) PCT No.: PCT/AU11/00848

§ 371 Date: Mar. 5, 2013

(30) Foreign Application Priority Data
Jul. 6, 2010 (AU) 2010902997

(51) Int. Cl. G06Q 20/10

(52) U.S. Cl. CPC G06Q 20/102
USPC 705/44

(57) ABSTRACT

A transaction management system (10) for managing transactions associated with a plurality of clients is disclosed. The transaction management system (10) comprises a client database (32) arranged to store transaction data associated with a plurality of clients. The transaction data includes creditor data indicative of outstanding creditor amounts, each creditor amount representing a monetary amount owed by a client to a creditor. The system also comprises a transaction manager device (24) arranged to facilitate access to the creditor data by the clients and to instigate payment to a creditor of a creditor amount in response to authorization by the client. The system (10) is arranged to enable electronic communications between the transaction manager device (24) and at least one remote client terminal (14) so that a client associated with the remote client terminal is able to access creditor data and authorize payment of a creditor from a remote location. A corresponding method is also disclosed.

### CROSS-REFERENCE TO RELATED APPLICATIONS

This is a nationalization under 35 U.S.C. §371(c) of International Application Serial Number PCT/AU2011/000848, filed Jul. 6, 2011, which claims priority to Australian Patent Application Serial No. 2010902977, filed Jul. 6, 2010. Priority is claimed to these applications, and both are incorporated herein by reference.

### FIELD OF THE INVENTION

The present invention relates to a transaction management system capable of managing transactions for a plurality of clients.

### BACKGROUND OF THE INVENTION

Trading businesses and individuals receive bills regularly and it is often a difficult task to manage payment of the bills, especially for a trading business wherein cash flow considerations can conflict with a desire to effect timely payment.

In order for a trading business to operate successfully, it is necessary for the business to maintain good accounts records so that business managers are provided with up to date information as to profitability of the business, and so that traditional accounts functions such as accounts receivable, and creditor and debtor management including receipt of payment of invoices can be satisfactorily managed.

However, such accounts administration functions are relatively expensive and time consuming for a business, and often detract from other profit generating activities of the business.

### SUMMARY OF THE INVENTION

In accordance with a first aspect of the present invention, there is provided a transaction management system for managing transactions associated with a plurality of clients, the transaction management system comprising:
a client database arranged to store transaction data associated with a plurality of clients, said transaction data including creditor data indicative of outstanding creditor amounts, each creditor amount representing a monetary amount owed by a client to a creditor; and
a transaction manager device arranged to facilitate access to the creditor data by the clients and to instigate payment to a creditor of a creditor amount in response to authorization by the client;
the system being arranged to enable electronic communications between the transaction manager device and at least one remote client terminal so that a client associated with the remote client terminal is able to access creditor data associated with the client and authorize payment of a creditor from a remote location;
wherein the creditors of monetary amounts owed by a client are not able to access the creditor data associated with the client, and for each creditor amount the timing of payment of the creditor amount to a creditor is under control of the client associated with the creditor amount such that payment of the creditor is not effected until authorization is confirmed by the client.

In one embodiment, at least one creditor amount represents a monetary amount owed by a first client associated with the system to a second client associated with the system such that the first client corresponds to a debtor and the second client corresponds to a creditor, the system being arranged to instigate payment to a creditor of a creditor amount in response to authorization by the debtor.

In one embodiment, the client database is arranged to store accounts data associated with a plurality of clients, the accounts data including the transaction data.

In one arrangement, the transaction manager device comprises a transaction manager application.

The transaction manager application may be arranged to facilitate entry and storage of the creditor data in the client database by a user associated with the transaction manager application. The creditor data may be stored in the client database in the form of a plurality of creditor records, each creditor record including information indicative of a creditor amount and an associated creditor.

In one embodiment, the system comprises a web server arranged to enable electronic communications between the transaction manager device and at least one remote client terminal by serving web pages to the at least one remote client terminal.

In one arrangement, a plurality of transaction manager applications are provided, each transaction manager application being associated with at least one client terminal, and each transaction manager application having an associated client database.

In one embodiment, the system is further arranged to store client information indicative of the identity of all clients associated with the system and transaction manager information indicative of the identity of all transaction managers associated with system. The client information and the transaction manager information may be stored in a system database.

In one arrangement, the client information includes, for each client, information indicative of a client financial account associated with the client from which payments to creditors are made and, optionally, to which payments from debtors are made. The client financial account may be a bank account or a credit card account.

The system may also be arranged to store creditor information indicative of the identity of creditors with which each client is associated and, for each creditor, information indicative of a creditor financial account associated with the creditor to which payments from clients are made.

In one arrangement, the system is further arranged to communicate electronically with a clearing house, the clearing house effecting transfer of monetary amounts from clients to creditors in response to a transfer instruction received from the system. For this purpose, the system may further comprise a control system application arranged to communicate with the clearing house and to instruct the clearing house to effect transfer of a monetary amount from a client to a creditor in response to transfer instructions received from a transaction manager application.

The control system application may be further arranged to control and coordinate storage of the client information and the transaction manager information in the system database.

In one variation, the transaction management system may be arranged to perform functions of the clearing house.

In one arrangement, the transaction management system is arranged to receive a confirmation communication indicative that an authorized transaction has been carried out and to modify the transaction data stored in the client database in response to receipt of the confirmation communication.

The client terminals may comprise a computing device, a PDA and/or a mobile telephone.

In one embodiment, the transaction management system is in the form of an account management system.

In one embodiment, the system is arranged to store files and/or documents relevant to each client associated with the system, the files and/or documents being accessible from a remote location by the client terminals.

In one embodiment, the system is arranged to display messages associated with a client on a client terminal and to enable a client to selectively remove a message from display using the client terminal. The messages may comprise a creditor reminder message indicative that a creditor amount is outstanding, a new file message indicative that a new file and/or document has been added to the system, or a new creditor message indicative that a new supplier has been added to the system.

In accordance with a second aspect of the present invention, there is provided a method of managing financial transactions of a plurality of clients, the method comprising:
storing transaction data associated with a plurality of clients in a client database, said transaction data including creditor data indicative of outstanding creditor amounts, each creditor amount representing a monetary amount owed by a client to a creditor;
facilitating electronic access to the creditor data by a client from a remote location;
facilitating authorization by a client of payment of a creditor amount to a creditor from a remote location; and
instigating payment to a creditor of a creditor amount in response to authorization by a client;
wherein the creditors of monetary amounts owed by a client are not able to access the creditor data associated with the client, and for each creditor amount the timing of payment of the creditor amount to a creditor is under control of the client associated with the creditor amount such that payment of the creditor is not effected until authorization is confirmed by the client.

In accordance with a third aspect of the present invention, there is provided a computer program which when loaded into a computer causes the computer to operate in accordance with a transaction management system for managing transactions associated with a plurality of clients, the transaction management system comprising:
a client database arranged to store transaction data associated with a plurality of clients, said transaction data including creditor data indicative of outstanding creditor amounts, each creditor amount representing a monetary amount owed by a client to a creditor; and
a transaction manager device arranged to facilitate access to the creditor data by the clients and to instigate payment to a creditor of a creditor amount in response to authorization by the client;
the system being arranged to enable electronic communications between the transaction manager device and at least one remote client terminal so that a client associated with the remote client terminal is able to access creditor data associated with the client and authorize payment of a creditor from a remote location;
wherein the creditors of monetary amounts owed by a client are not able to access the creditor data associated with the client and the timing of payment of the creditors is under control of the client such that payment of a creditor is not effected until authorization is confirmed by the client.

### BRIEF DESCRIPTION OF THE DRAWINGS

The present invention will now be described, by way of example only, with reference to the accompanying drawings, in which;

FIG. 1 is a schematic block diagram of a transaction management system in accordance with an embodiment of the present invention shown in relation to a plurality of client terminals and a clearing house;

FIG. 2 is a representation of a transaction manager table of the transaction management system shown in FIG. 1;

FIG. 3 is a representation of a system client table of the transaction management system shown in FIG. 1;

FIG. 4 is a representation of a manager client table of the transaction management system shown in FIG. 1;

FIG. 5 is a representation of a manager login table of the transaction management system shown in FIG. 1;

FIG. 6 is a representation of a suppliers table of the transaction management system shown in FIG. 1;

FIG. 7 is a representation of a creditors table of the transaction management system shown in FIG. 1;

FIG. 8 is a representation of an add bills table of the transaction management system shown in FIG. 1;

FIG. 9 is a representation of an authorization table of the transaction management system shown in FIG. 1;

FIG. 10 is a representation of a transaction communication used by the transaction management system shown in FIG. 1;

FIG. 11 is a representation of a files table of the transaction management system shown in FIG. 1;

FIG. 12 is a representation of a messages table of the transaction management system shown in FIG. 1; and

FIG. 13 is a flow diagram illustrating steps of a process for transferring payment to a creditor carried out by the transaction management system shown in FIG. 1.

### DESCRIPTION OF AN EMBODIMENT OF THE INVENTION

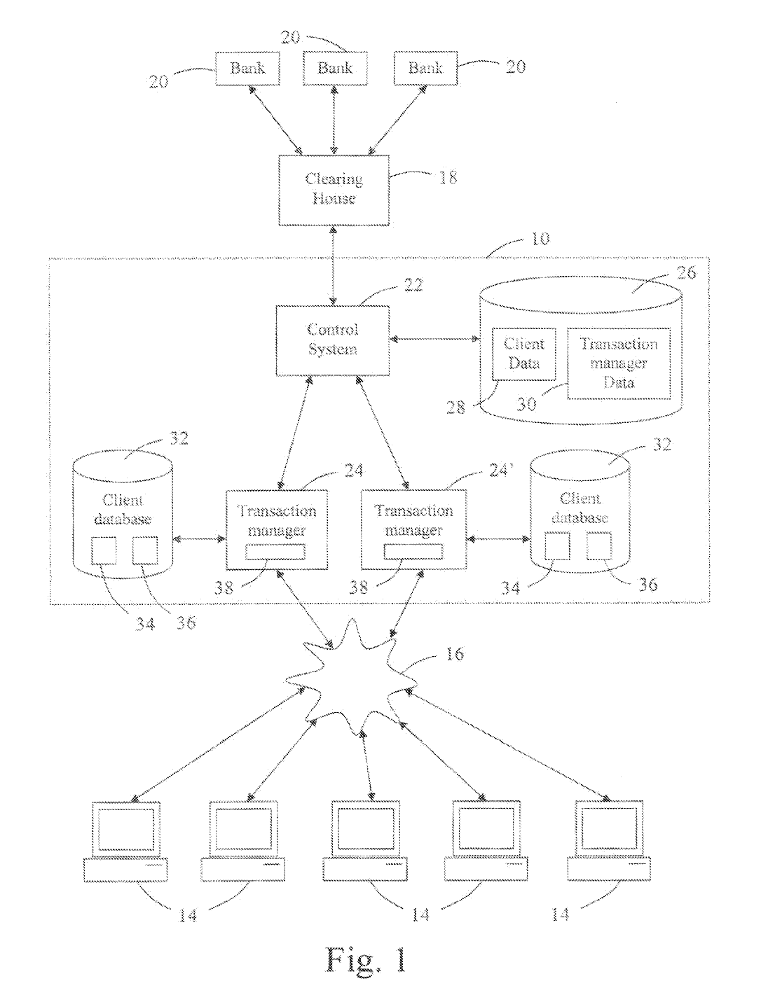

Referring to the drawings, in FIG. 1 there is shown a transaction management system 10 shown schematically. In this example, the transaction management system is in the form of an account management system usable by a client to outsource at least one accounts function associated with the client. However, it will be understood that other variations are possible.

The system 10 is accessible by a plurality of client terminals 14 from respective remote locations, in this example through the Internet 16. In this example, each client terminal 14 is associated with a respective trading business or individual, referred to hereinafter as a “client”, desiring to outsource financial administration functions.

Each client terminal 14 in this example is a personal computing device, although it will be understood that other types of client terminal are envisaged, the important aspect being that the client terminal 14 is capable of communicating with the transaction management system 10 from a remote location. As such, the client terminals 14 may include personal digital assistants (PDA), mobile telephones, and so on.

The transaction management system 10 is remotely located relative to the client terminals 14 and is arranged to manage financial transactions between a client and a creditor, and in particular in this example to support accounting functions required by the businesses associated with the client terminals 14, such as accounts receivable functions, and creditor and debtor management functions including payment of creditor invoices. In this way, the transaction management system 10 enables the businesses associated with the client terminals 14 to outsource financial administration functions of the businesses and thereby improve accounts management efficiency and reduce costs.

The transaction management system 10 communicates with a clearing house 18 which serves to control and coordinate financial transactions between client and creditor financial accounts represented in FIG. 1 by banks 20. In particular, based on instructions received from the transaction management system 10, the clearing house 18 coordinates transfer of money from a client bank account to a creditor bank account in response to authorization by the client.

The transaction management system 10 in this example includes a control system application 22 arranged to communicate with the clearing house 18, and a plurality of transaction manager applications 24, 24′ which communicate with the control system application 22 and which are arranged to communicate through the Internet 16 with the client terminals 14. Each transaction manager application 24, 24′ is associated with a business, referred to hereinafter as a “transaction manager”, desiring to manage financial transactions of a plurality of client businesses. In this example, each transaction manager is arranged to manage outsourced financial administration functions including financial transaction functions.

The control system application 22 also communicates with a master database 26 which holds system data including client data 28 representative of all clients associated with the transaction management system 10, and transaction manager data 30 representative of all transaction managers associated with the transaction management system 10.

Operation of the transaction management system 10 is such that details of clients which become associated with the system 10 are stored in the master database 26, with each client being associated with one of the transaction manager applications 24, 24′ so that financial administration functions of the client are outsourced to the transaction manager application 24, 24′.

For this purpose, each transaction manager application 24, 24′ has an associated client database 32 arranged to store client related data including client account records 34 indicative of accounts information associated with the clients such as supplier information, creditor information, debtor information, accounts receivable information, accounts reconciliation information, and so on. Each client database 32 is also arranged to store client details 36 indicative of the clients associated with each of the transaction manager applications 24, 24′, login details for users authorized to access the client records 34, relevant financial account details of the client from which payments to creditors will be made, and so on.

While the present embodiment is described in relation to a control system application 22 and a plurality of transaction manager applications 24, 24′, it will be understood that other implementations are possible. For example, a single transaction manager application may be provided with the transaction manager application arranged to perform functions performed in the present embodiment by the control system application 22 and the transaction manager applications 24, 24′.

It will also be understood that in a practical application of the transaction management system 10, the control system application 22 may be associated with a licensor organization and each of the transaction manager applications 24, 24′ may be associated with a licensee organization so that control over operation of the system as a whole may be maintained by operators of the control system application 22 whilst permitting a large number of distinct and distributed transaction manager organizations to provide outsourced financial administration services to clients in multiple geographical locations.

It will also be understood that while the present embodiment includes a clearing house 18 which is separate to the transaction management system 10, it will be understood that the functions of the clearing house 18 may be incorporated into the transaction management system 10, for example by arranging the control system application 22 to also perform clearing house functions.

During use, representatives of clients associated with the client terminals 14 periodically forward transaction information, and in this example other accounts related information, to the relevant associated transaction managers, for example by e-mail, standard mail or facsimile, and on receipt of the transaction information, representatives of the transaction managers enter accounts information into the relevant transaction manager application 24, 24′ so that the accounts information is stored in the relevant client database 32.

In order that the client data can be made available to the clients, in this embodiment each transaction manager application 24, 24′ has an associated web server 38 which serves client data to a client terminal 14 within a framework determined by the transaction manager application 24, 24′ on request of the client terminal 14.

Using the client terminal 14, a representative of the client is able to view client related account information, including information relating to outstanding creditors. The client representative is also able to authorize payment of creditor invoices, as will be discussed in more detail below.

It will be appreciated that in order for representatives of the transaction manager application 24 to effect payments of invoices, appropriate authorization for the transaction manager to effect payments from a client's financial account (eg. bank account or credit card account) would be given, for example in the form of a power of attorney.

It will be appreciated that the present system serves to enable a business to outsource management and payment of invoices received by the business, and in this way the system creates a payment administrator for a business. The payment administrator hold records of invoices received by a business, and is authorized to make payments in respect of the invoices on behalf of the business using one or more financial accounts associated with the business when authorized by the business.

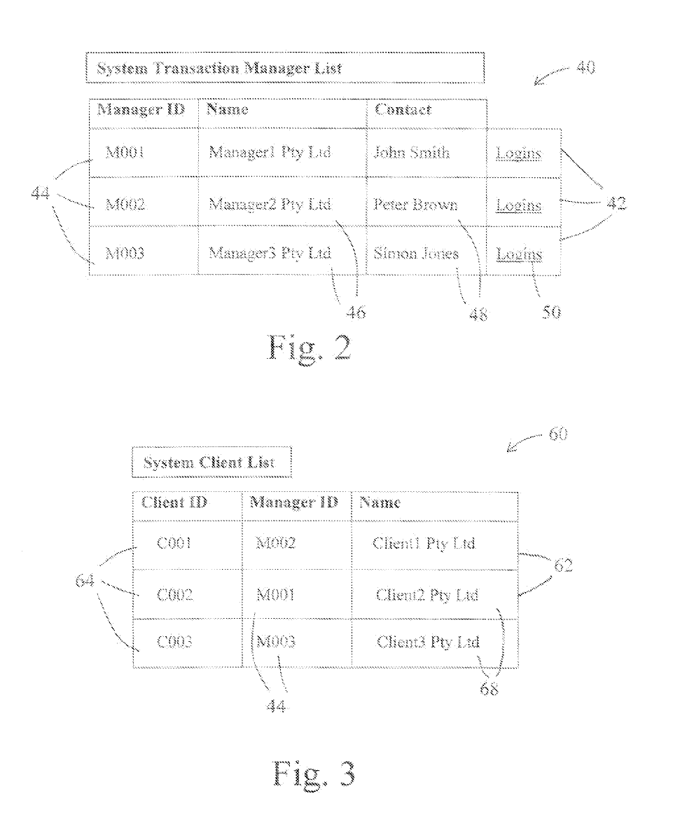

An example of operation of the transaction management system 10 will now be described with reference to FIGS. 2 to 13.

The transaction management system 10 is arranged such that representatives of the control system application 22, representatives of the transaction managers, and representatives of clients each have a set of associated login accounts which govern the users authorized to access the control system application 22 and the transaction manager applications 24, 24′ and the level of access permitted.

As shown in FIG. 2, the transaction manager data 30 stored in the master database 26 includes basic information associated with all transaction managers. The transaction manager data 30 is represented in FIG. 2 as a transaction manager table 40 including a plurality of transaction manager records 42. Each transaction manager record 42 in this example includes a unique transaction manager identification reference 44, the name 46 of the transaction manager organization, details of a primary transaction manager contact 48, and a manager login hyperlink 50 which may be activated so as to facilitate creation and modification of login accounts associated with the transaction managers.

The client data 28 stored in the master database 26 includes basic details of all clients associated with the transaction management system 10. In FIG. 3, the client data is represented as a system client table 60 including a plurality of client records 62. Each client record 62 includes a unique client identification reference 64, the transaction manager reference 44 of the transaction manager organization with which the client is associated, and the name of the client organization 68.

The transaction manager table 40 and the system client table 60 are accessible only by users associated with operators of the control system application 22 and provided with the appropriate access level.

Authorized users of a transaction manager application 24, 24′ are able to login to the transaction manager application 24, 24′ and view details of client organizations which are associated with the transaction manager application 24, 24′.

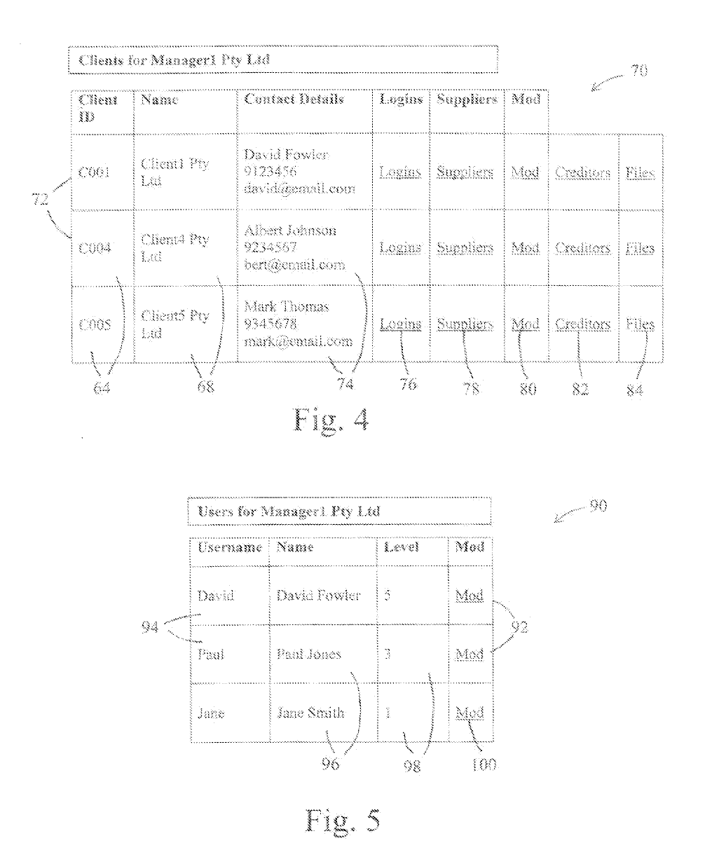

An example manager client table 70 presented to an authorized user of a transaction manager application 24, 24′ after successful login is shown in FIG. 4.

The manager client table 70 includes a plurality of client records 72, each client record 72 being associated with a client organization associated with the transaction manager application 24, 24′ and including the relevant client ID 64, the client name 68, details of a contact representative of the client 74, a client login hyperlink 76, a suppliers hyperlink 78, a modification hyperlink 80, a creditors hyperlink 82 and a files hyperlink 84.

Each client record may also include a hyperlink to an associated debtor table (not shown), the debtor table including one or more debtor records indicative of one or more debtors associated with a client.

As represented by client logins table 90 in FIG. 5, activation of a client login hyperlink 76 causes the transaction manager application 24, 24′ to display a client logins table 90 usable to add or modify login details for users of the transaction manager application 24, 24′.

The client logins table 90 includes a plurality of login records 92, each login record 92 including details of a username 94, the name 96 of the user associated with the username 94, the level of access allocated to the user 98, and a login modification hyperlink 100 which, when activated, enables an authorized user of the transaction manager business to modify details of existing users and/or add or delete users depending on the access level granted to the user.

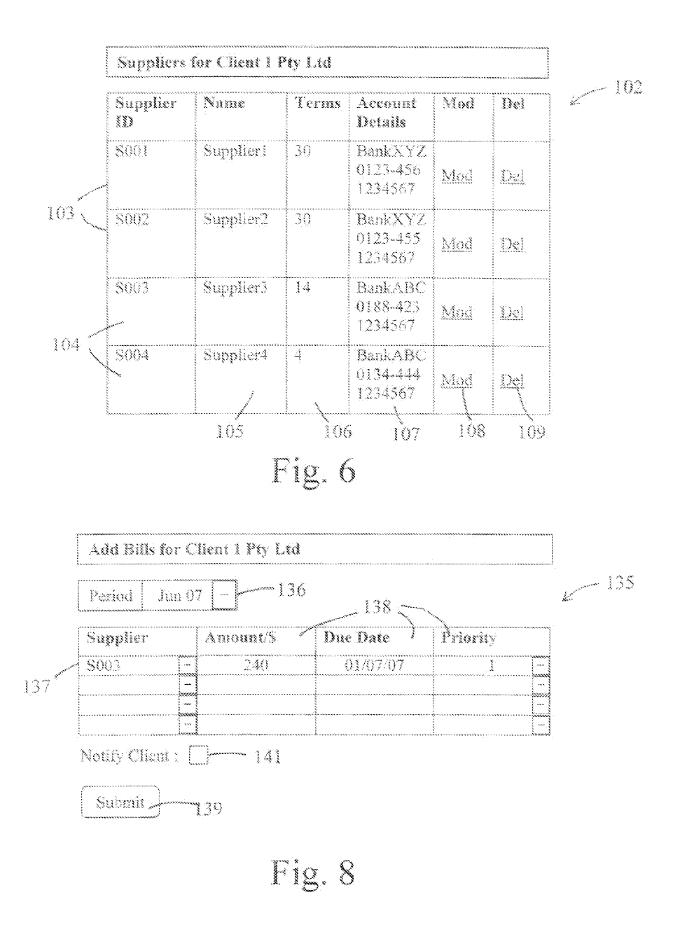

Activation of the suppliers hyperlink 78 on the manager client table 70 causes the transaction manager application 24, 24′ to display a suppliers table 102 as shown in FIG. 6. The suppliers table 102 includes a plurality of supplier records 103, the supplier records 103 including details of all suppliers associated with a client. In this example, each supplier record 103 includes a supplier identification reference 104, a supplier name 105, payment terms 106, bank account details 107 for receiving payments from a client, and modification and delete hyperlinks 108, 109 usable to modify and delete supplier records 103.

It will be appreciated that the suppliers associated with a client may or may not also be clients of the system 10 and the suppliers need not be aware that the client is using the system to effect payment of invoices. This is because, from the perspective of the suppliers, invoices are paid in the same way in that electronic payment of the invoices is made, for example through a clearing house, from a client's bank account or credit card.

Activation of the modifications hyperlink 80 on the manager client table 70 enables an authorized user of the transaction manager application 24, 24′ to modify details of a client associated with the transaction manager application 24, 24′ and/or to add or delete clients associated with the transaction manager application 24, 24′.

Activation of the creditors hyperlink 82 on the manager client table 70 causes the transaction manager application 24, 24′ to display a creditors table 110 as shown in FIG. 7. The creditors table 110 includes a plurality of creditor records 112 for a client, each creditor record 112 including details of a monetary amount owed to a supplier by the client.

Each creditor record 112 includes information indicative of the relevant financial period 114; the due date 116 by which the relevant supplier requires payment; the name of the supplier 118; the amount 120 owed to the supplier; the amount if any already authorized for payment 122; the amount outstanding 124; the priority level 126; the date 128 when at least part of the amount 120 was authorized if any; a modifications hyperlink 130 usable to modify creditor records 112, for example to modify a creditor record 112 when an invoice from a supplier has been at least partially paid; a delete hyperlink 132 usable to delete the creditor record 112; and a reminder hyperlink 134 which, when activated, enables an operator of the transaction manager application 24, 24′ to generate a reminder for a client that an amount remains outstanding with a supplier.

It will be understood that a reminder may be forwarded to a client by e-mail or may be made available for viewing by the client on-line, as will be discussed in more detail below.

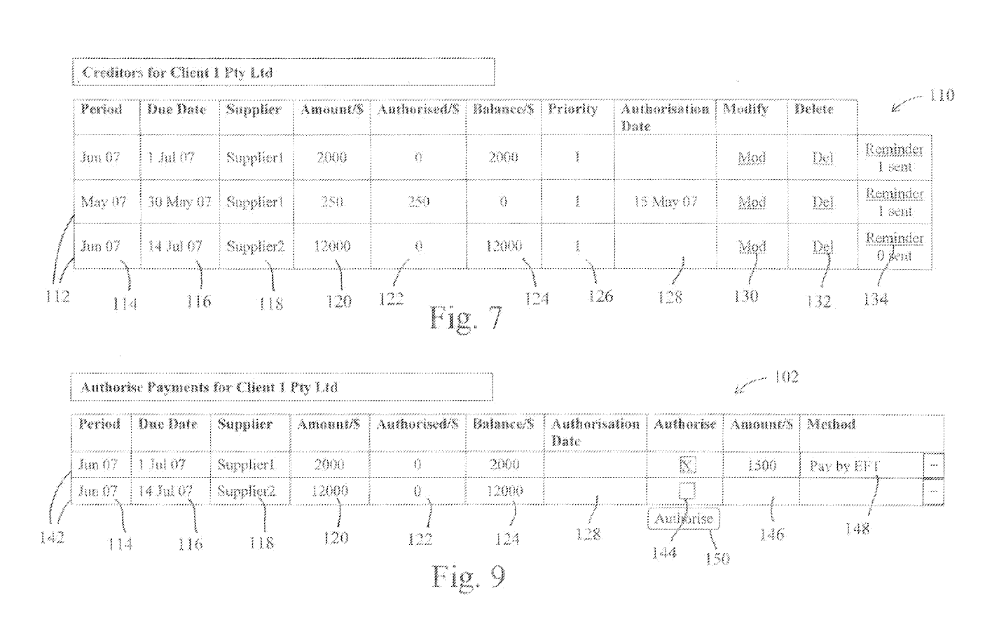

As represented by add bills table 135 shown in FIG. 8, a representative of a transaction manager is able to enter details of a new bill on receipt of the bill from the client.

The add bills table 135 includes a period drop down box 136 usable to select the relevant accounting period for the bill, a supplier selection drop down box 137 usable to select the supplier associated with the new bill; invoice amount, due date and priority level boxes 138; and a submit button 139 usable to confirm details of the new bill and cause the system 10 to create a new creditor record 112 in the creditors table 110 shown in FIG. 7. A notify client checkbox 141 is also included which, when checked, causes the transaction manager application 24, 24′ to generate a notification to a client that the new bill has been added. The notification may be communicated to the client in any suitable way, for example by email or by adding a communication to a message table as discussed in more detail below.

It will be understood that in a similar way to operation of the add bills table 135, bills which have been generated by a client may be entered into the system 10 to appear as new debtor records in a debtors table (not shown).

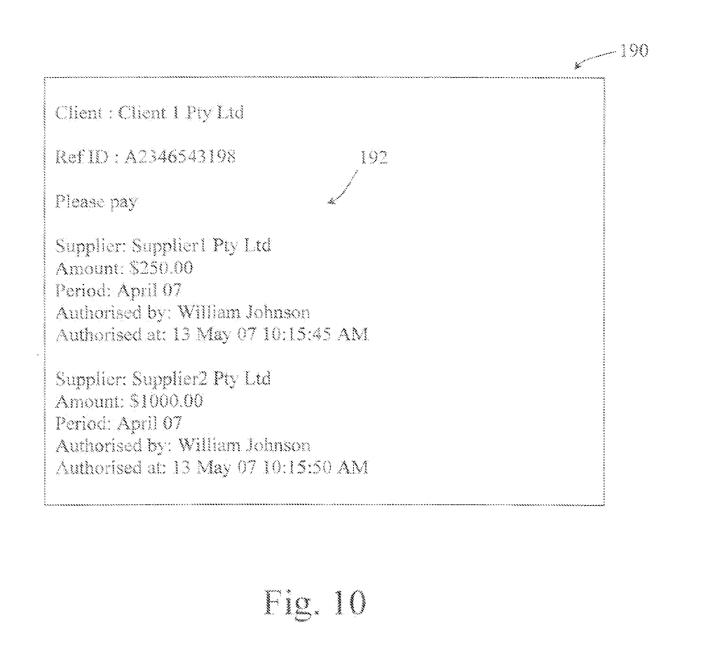

Using a client terminal 14, a representative of the client is able to access the transaction manager application 24, 24′ associated with the client. In doing so, the client representative is provided with an option to view outstanding creditor amounts, represented by authorization table 140 shown in FIG. 9. In this example, the authorization table 140 is served to the client terminal 14 by the web server 38. The authorization table 140 includes a plurality of authorization records 142 which are associated with the client business and which are outstanding. Each authorization record 142 includes details of the relevant financial period 114; the due date 116 by which the supplier 118 requires payment; the relevant amount 120; the amount already authorized 122; the balance amount 124; the authorization date 128 corresponding to the date at which at least part of an amount owed to the supplier 118 was authorized; an authorization checkbox 144; an amount field 146; and a payment method drop down box 148.

It will be understood that by activating a relevant authorization checkbox 144, entering an amount which is desired to be paid to a supplier into the amount field 146 and selecting an appropriate payment method using the payment method drop down box 148, an authorized representative of the client is able to select and authorize payment of an amount to a supplier 118. After completion of the authorization checkbox 144 and the amount and payment method fields 146, 148, authorization is confirmed by activating an authorization confirmation button 150.

Activation of the confirmation button 150 causes an authorization communication 190, an example of which is shown in FIG. 10, to be sent from the transaction manager application 24, 24′ to the control system 22 and for the control system 22 to communicate with the clearing house 18 so as to effect transfer of a monetary amount from an account associated with the client, details of which are recorded in the relevant client record 72, to an account associated with the supplier, details of which are recorded in the relevant supplier record 103. The authorization communication 190 contains transaction details 192 including details of the supplier to receive payment, the payment amount and period and details of the person authorizing the transaction, and the time at which authorization occurred. The transaction details 192 also include the name of the client organization and a transaction identification code unique to the authorization communication 190.

The system may also be arranged to delay transfer of the monetary amount to the account associated with the supplier, for example until a specified time in the day, in order to allow the transaction to be cancelled, such as by the transaction manager because the transfer is in error or because the client does not have sufficient funds for the transfer.

After completion of the or each transaction contained in the authorization communication 190, the clearing house 18 forwards a transaction confirmation communication to the control system 22 and the control system 22 forwards the confirmation communication to the relevant transaction manager 24, 24′. Alternatively, the clearing house 18 may forward the confirmation communication directly to the relevant transaction manager 24, 24′.

On receipt of the confirmation communication, the transaction manager 24, 24′ automatically modifies the relevant creditor record(s) 112 so as to indicate that the or each amount covered by the transactions have been paid to the relevant suppliers.

Using the files hyperlinks 84 on the manager client table 70, operators of the transaction manager application 24, 24′ are able to store files and/or documents associated with clients in the client database 32. Such documents may include pay slips; human resources material such as leave policy documents, request for leave forms and employment contracts; marketing information such as marketing brochures; and high level financial documents relating to the client's business such as BAS statements.

As represented by a files table 160 shown in FIG. 11, documents and files are stored in the client database 32 for a particular client, and the documents and files are accessible by the client using the client terminal 14.

The files table 160 includes a plurality of file records 161, each file record including details of the relevant period 114; the name of a file 162; the relevant category for the file 164; an allocatable access level 166 for the file, an indication 168 as to whether authorization for access to the file has been given or is requested, a view hyperlink 170 usable to view the file, and a delete hyperlink 172 usable to delete the file record containing the file.

It will be understood that by providing such a readily accessible repository for documents and files relating to a client business, it is possible for a client to outsource document management and provide representatives and employees of the client with a user friendly central location for accessing documents and files associated with the client business.

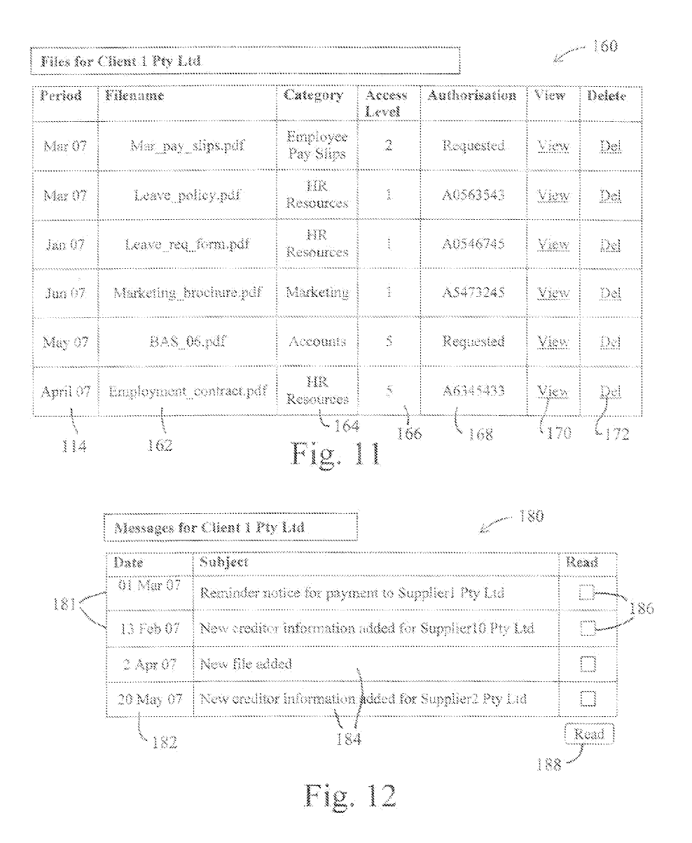

Using the client terminal 14, a representative of the client is also able to access messages generated by operators of the transaction manager application 24, 24′. As shown in FIG. 12, the messages may be presented in the form of a messages table 180 which includes a plurality of message records 181, each message record including details of the date of creation 182 of the message; a description of the subject of the message 184; and a message read checkbox 186. The messages table 180 may also be arranged so that full details of the message may be viewed either by including a hyperlink in each of the message records 181 or by displaying the full message when a mouse cursor is positioned over the message record 181.

The message records 181 may relate to any communication desired to be sent to a client, such as reminder notices for payment of creditors created by operators of the transaction manager application 24, 24′ using the reminder hyperlinks 134 on the creditors table 110; to indicate that new creditor information has been added, for example because a new invoice has been received by the operators of the transaction manager application 24 from a client; or to indicate that a new file has been added and is viewable on the files table 160.

After reading a message, a user may mark the relevant read checkbox 186 and activate a read confirmation button 188 so as to remove the message record 181 associated with the read message for display.

The above example is described in relation to an arrangement wherein a client of the system has multiple creditors with the creditors being associated with the system only in that the system holds details of a financial account for the purpose of receiving payments from the client. However, it will be appreciated that other arrangements are possible. For example, it is envisaged that the client and creditor may both be associated with the system such that the system is also applicable to a first client which may be referred to as a debtor and a second client which may be referred to as a creditor. With this arrangement, transaction data associated with the first and second clients are both stored in the client database and are respectively accessible by the first and second clients.

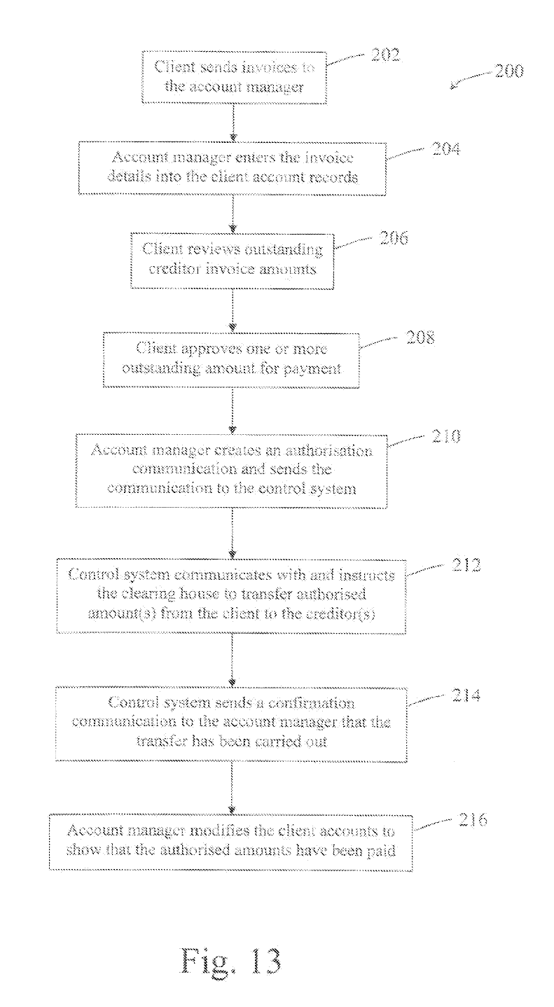

Operation of the transaction management system 10 in relation to payment of an invoice received by a client is shown in flow diagram 200 in FIG. 13.

As indicated by steps 202 to 216, on receipt of an invoice from a supplier, a client forwards the invoice to the transaction manager with which the client is associated, and on receipt of the invoice an operator of the transaction manager application enters the invoice details so that a client record 112 is created in the creditors table 110 and an authorization record 142 is created in the authorization table 140. Periodically, or as necessary, the operators of the transaction manager application 24, 24′ may generate, or the transaction manager application 24, 24′ may itself automatically generate, one or more reminders for the client which appear on the messages table 180 for viewing by the client. In addition, or alternatively, a reminder message may be forwarded to the client by e-mail.

A representative of the client then accesses the transaction manager application 24, 24′ and using the authorization table 140 authorizes one or more amounts for payment. This causes the transaction manager application 24, 24′ to generate an authorization communication and the transaction manager application 24, 24′ sends the authorization communication to the control system 22. On receipt of the authorization communication, the control system communicates with the clearing house 18 and the clearing house 18 causes the authorized amounts to be transferred from an account associated with the client to an account associated with the supplier. After the transfer has been effected, a confirmation communication is forwarded to the transaction manager application 24, 24′ which modifies the relevant creditor record 112 and authorization record 142 so as to indicate that the payment has been made.

While the above embodiment is described in relation to a transaction system which serves to manage accounts functions of a client business including payment of bills, it will be understood that other arrangements are possible. For example, the client may be an individual and the system may be arranged to manage payment of bills received by the individual. With this arrangement, bills received by the individual may be forwarded by the client or by the bill issuing organization to operators of the system for entry in a client database, and the outstanding bills reviewed by the individual and authorized for payment under control of the individual. In this way, it is possible for bills received by an individual to be efficiently managed and for the individual to more easily manage payment of the bills.

It will be appreciated that although the present embodiment is implemented primarily in software, other implementations of the invention are possible. For example, the invention may be implemented at least partly in hardware.

The present invention may also take the form of a computer program, which may be stored on a computer readable medium such as a computer disk, the program being loadable into a computer and being arranged when loaded into a computer to cause the computer to implement an transaction management system according to the above embodiment.

Modifications and variations as would be apparent to a skilled addressee are deemed to be within the scope of the present invention.

1-34. (canceled)

35. A transaction management system for managing transactions associated with a plurality of clients, the transaction management system comprising:
a client database arranged to store transaction data associated with a plurality of clients, said transaction data including creditor data indicative of outstanding creditor amounts, each creditor amount representing a monetary amount owed by a client to a creditor; and
a transaction manager device arranged to facilitate access to the creditor data by the clients and to instigate payment to a creditor of a creditor amount in response to authorization by the client;
the system being arranged to enable electronic communications between the transaction manager device and at least one remote client terminal so that a client associated with the remote client terminal is able to access creditor data associated with the client and authorize payment of a creditor from a remote location;
wherein the creditors of monetary amounts owed by a client are not able to access the creditor data associated with the client, and for each creditor amount the timing of payment of the creditor amount to a creditor is under control of the client associated with the creditor amount such that payment of the creditor is not effected until authorization is confirmed by the client.

36. A transaction management system as claimed in claim 35, wherein at least one creditor amount represents a monetary amount owed by a first client associated with the system to a second client associated with the system such that the first client corresponds to a debtor and the second client corresponds to a creditor, the system being arranged to instigate payment to a creditor of a creditor amount in response to authorization by the debtor.

37. A transaction management system as claimed in claim 35, wherein the client database is arranged to store accounts data associated with a plurality of clients, the accounts data including the transaction data.

38. A transaction management system as claimed in claim 35, wherein the transaction manager device comprises a transaction manager application.

39. A transaction management system as claimed in claim 38, wherein the transaction manager application is arranged to facilitate entry and storage of the creditor data in the client database by a user.

40. A transaction management system as claimed in claim 35, wherein a plurality of transaction manager applications are provided, each transaction manager application being associated with at least one client, and each transaction manager application having an associated client database.

41. A transaction management system as claimed in claim 35, wherein each transaction manager device is associated with a transaction manager and the system is arranged to store client information indicative of the identity of all clients associated with the system and transaction manager information indicative of the identity of all transaction managers associated with system.

42. A transaction management system as claimed in claim 41, wherein the client information includes, for each client, information indicative of a client financial account associated with the client from which payments to creditors are made.

43. A transaction management system as claimed in claim 35, wherein the system is arranged to store creditor information indicative of the identity of creditors with which each client is associated and, for each creditor, information indicative of a creditor financial account associated with the creditor to which payments from clients are made.

44. A transaction management system as claimed in claim 35, wherein the system is further arranged to communicate electronically with a clearing house arranged to effect transfer of monetary amounts from clients to creditors in response to a transfer instruction received from the system.

45. A transaction management system as claimed in claim 44, comprising a control system application arranged to communicate with the clearing house and to instruct the clearing house to effect transfer of a monetary amount from a client to a creditor in response to transfer instructions received from a transaction manager application.

46. A transaction management system as claimed in claim 35, wherein the transaction management system is arranged to perform functions of a clearing house.

47. A transaction management system as claimed in claim 35, wherein the transaction management system is arranged to receive a confirmation communication indicative that an authorized transaction has been carried out and to modify the transaction data stored in the client database in response to receipt of the confirmation communication.

48. A transaction management system as claimed in claim 35, wherein the system is arranged to store files and/or documents relevant to each client associated with the system, the files and/or documents being accessible from a remote location by the client terminals.

49. A transaction management system as claimed in claim 35, wherein the system is arranged to display messages associated with a client on a client terminal and to enable a client to selectively remove a message from display using the client terminal.

50. A method of managing financial transactions of a plurality of clients, the method comprising:
storing transaction data associated with a plurality of clients in a client database, said transaction data including creditor data indicative of outstanding creditor amounts, each creditor amount representing a monetary amount owed by a client to a creditor;
facilitating electronic access to the creditor data by a client from a remote location;
facilitating authorization by a client of payment of a creditor amount to a creditor from a remote location; and
instigating payment to a creditor of a creditor amount in response to authorization by a client;
wherein the creditors of monetary amounts owed by a client are not able to access the creditor data associated with the client, and for each creditor amount the timing of payment of the creditor amount to a creditor is under control of the client associated with the creditor amount such that payment of the creditor is not effected until authorization is confirmed by the client.

51. A method as claimed in claim 50, wherein at least one creditor amount represents a monetary amount owed by a first client associated with the system to a second client associated with the system such that the first client corresponds to a debtor and the second client corresponds to a creditor, the method comprising instigating payment to a creditor of a creditor amount in response to authorization by the debtor.

52. A method as claimed in claim 50, comprising storing accounts data associated with a plurality of clients in the client database, the accounts data including the transaction data.

53. A method as claimed in claim 50, comprising providing a plurality of transaction manager applications, each transaction manager application being associated with at least one client terminal, and each transaction manager application having an associated client database.

54. A method as claimed in claim 50, comprising storing client information indicative of the identity of all clients and transaction manager information indicative of the identity of all transaction managers.

55. A method as claimed in claim 54, wherein the client information includes, for each client, information indicative of a client financial account associated with the client from which payments to creditors are made.

56. A method as claimed in claim 50, comprising storing creditor information indicative of the identity of creditors with which each client is associated and, for each creditor, information indicative of a creditor financial account associated with the creditor to which payments from clients are made.

57. A method as claimed in claim 50, comprising communicating electronically with a clearing house arranged to effect transfer of monetary amounts from clients to creditors in response to a transfer instruction received from the system.

58. A method as claimed in claim 50, comprising receiving a confirmation communication indicative that an authorized transaction has been carried out and modifying the transaction data stored in the client database in response to receipt of the confirmation communication.

59. A method as claimed in claim 50, comprising storing files and/or documents relevant to each client associated with the system, the files and/or documents being accessible from a remote location by the client terminals.

60. A method as claimed in claim 50, comprising displaying messages associated with a client on a client terminal and enabling a client to selectively remove a message from display using the client terminal.
